(19) United States
(12) Patent Application Publication
(10) Pub. No.: US 2007/0205634 A1
(43) Pub. Date: Sep. 6, 2007

(54) Access panel

(75) Inventors: Donald S. Hanson, Evans, GA (US); Bradley J. Hanson, North Augusta, SC (US)

Correspondence Address: HARNESS, DICKEY & PIERCE, P.L.C., P.O. BOX 828, BLOOMFIELD HILLS, MI, 48303, US

(73) Assignee: Textron Inc., Providence, RI (US)

(21) Appl. No.: 11/365,905

(22) Filed: Mar. 1, 2006

(51) Int. Cl. B62D 25/00

(52) U.S. Cl. 296/191

(57) ABSTRACT

An access panel for a golf car that can comprise a first planar portion; a second planar portion integral with and orientated at an angle relative to the first planar portion; a first retention detail extending from the first planar portion; a second retention detail extending from the second planar portion; and an aperture extending through the first planar portion.

### FIELD

The present disclosure relates to a method and apparatus for facilitating access to the powertrain of a golf car.

### BACKGROUND

The statements in this section merely provide background information related to the present disclosure and may not constitute prior art.

Golf cars can include a rear opening in a rear body of the golf car to provide access to components of the golf car below the rear body, such as the power train. A cover can be provided for covering the rear opening. The cover can be secured in the opening using a plurality of fasteners, often at the corners of the cover. Typically, six or more fasteners are used to securely mount the cover in the opening. The use of such a fastening system often makes it cumbersome to remove the cover from, and secure the cover within, the opening. Thus, such covers and fastening systems for such covers are subject to improvement.

### SUMMARY

The present teachings provide for an access panel for a golf car that can comprise a first planar portion; a second planar portion integral with and orientated at an angle relative to the first planar portion; a first retention detail extending from the first planar portion; a second retention detail extending from the second planar portion; and an aperture extending through the first planar portion.

The present teachings also provide for a golf car that can comprise a front end; a rear end opposite the front end; a rear body at the rear end comprising an upper portion and a golf bag retention well; and an opening that extends from the upper portion of the rear body to the retention well. The opening can comprise a first flange at the upper portion of the rear body; a second flange at the retention well of the rear body; a first notch in the first flange; and a second notch in the second flange.

The present teachings further provide for a rear body of a golf car that can comprise an upper portion; a golf bag retention well adjacent to the upper portion and recessed beneath the upper portion; an opening in the rear body extending from the upper portion to the golf bag retention well; a cover having a first planar portion and a second planar portion that is integral with the first planar portion at a hinge portion, the first planar portion is angled relative to the second planar portion, the cover is sized to cover the opening; and a plurality of retention details mounted to the cover and operable to cooperate with the opening to retain the cover in the opening.

The present teachings still further provide for a golf car comprising: a front end; a rear end opposite to the front end; a rear body at the rear end comprising an upper portion and a golf bag retention well; an opening that extends from the upper portion of the rear body to the retention well; and a cover covering the opening. The opening comprises: a first flange at the upper portion of the rear body; a second flange at the retention well of the rear body; a first notch in the first flange; and a second notch in the second flange. The cover comprises: a first planar portion; a second planar portion that is integral with the first planar portion at a hinge portion, the first planar portion is angled more than 90° relative to the second planar portion; a first retention detail extending from the first planar portion; and a second retention detail extending from the second planar portion. The cover is flexed at the hinge portion to bring the first planar portion into contact with the first flange and the second planar portion into contact with the second flange, the first planar portion is positioned such that the first planar portion is seated atop the first flange and the first retention detail is seated within the first notch and below the first flange, the second planar portion is positioned such that the second planar portion is seated atop the second flange and the second retention detail is seated within the second notch and below the second flange.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a perspective view of a golf car according to various embodiments;

FIG. 2 is a rear end of the golf car of FIG. 1;

FIG. 3A is a perspective view of the rear end of the golf car showing a rear cover of the golf car;

FIG. 3B is a perspective view of the rear end of the golf car with the rear cover removed;

FIG. 4 is a perspective view of an upper surface of the rear cover;

FIG. 5 is a perspective view of an undersurface of the rear cover;

FIG. 6 is a side view of the rear cover; and

FIG. 7 is a close-up perspective view of a retention detail of the rear cover.

### DETAILED DESCRIPTION

The following description is merely exemplary in nature and is in no way intended to limit the present disclosure, application, or uses. Throughout this specification, like reference numerals will be used to refer to like elements.

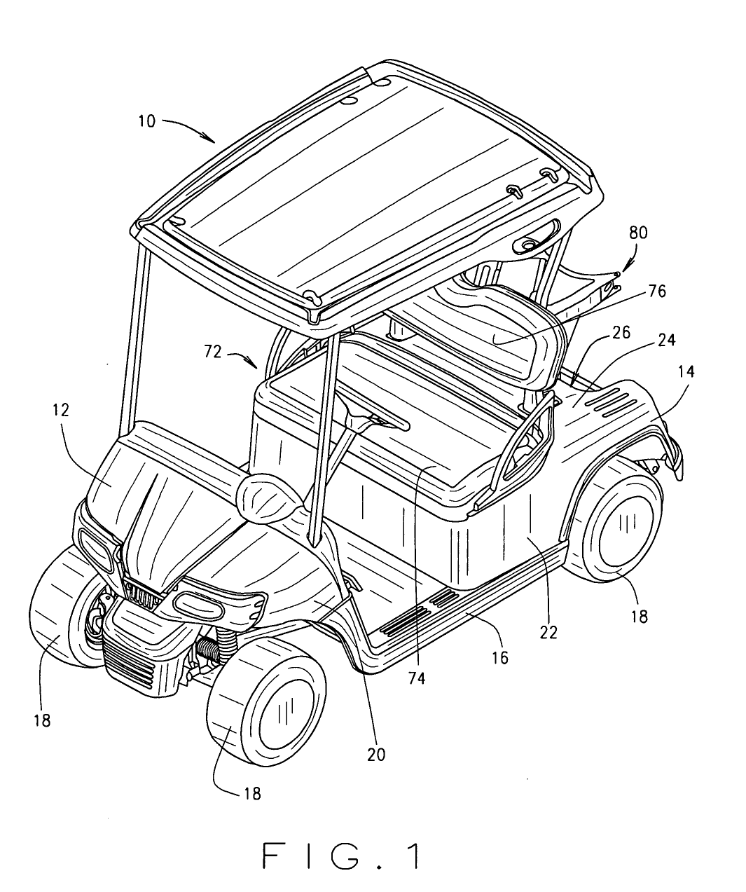

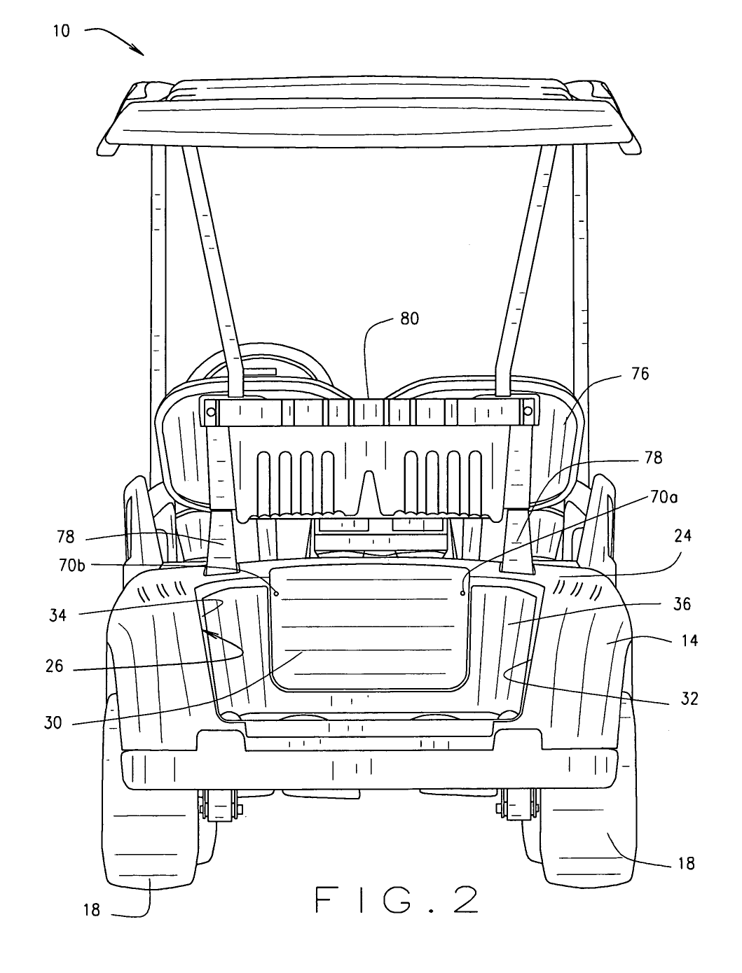

A golf car according to the present teachings is illustrated in FIGS. 1 and 2 at reference numeral 10. The golf car 10 can comprise a front end 12 and a rear end 14 that can be opposite the front end 12. The golf car 10 can further comprise a frame 16 supported by a plurality of wheels 18. A front body 20 can be mounted to the frame 16 at the front end 12 of the car 10. A rear body 22 can be mounted to the frame 16 at the rear end 14 of the car 10.

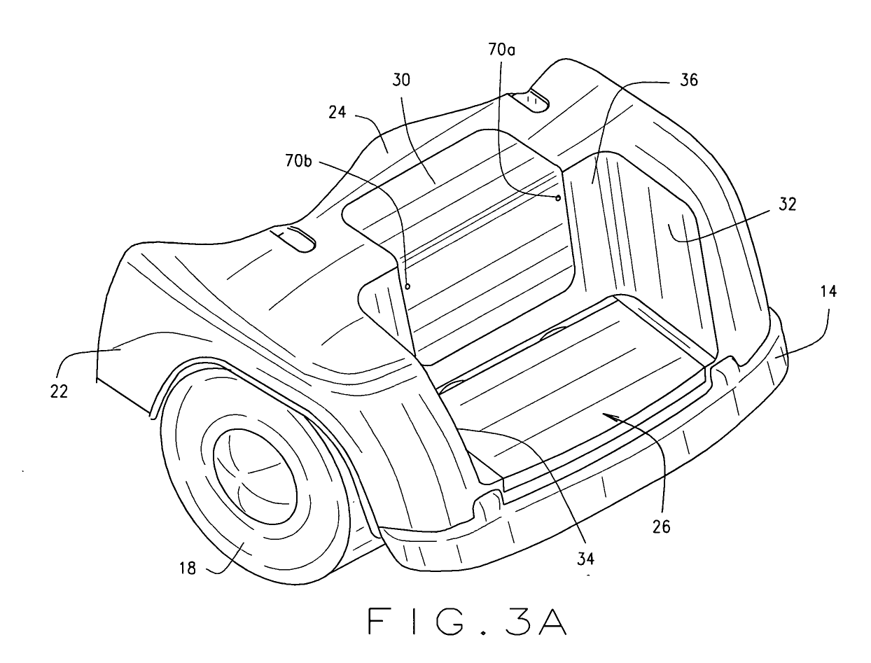

The rear body 22 can comprise an upper portion 24, a well 26, an opening 28 (FIG. 3B), and a cover 30 for said opening 28. With additional reference to FIGS. 3A and 3B, the well 26 can be recessed within the upper portion 24 at the rear end 14 of the car 10. The well 26 can include a first side wall 32 and a second side wall 34. The first side wall 32 can be generally parallel to the second side wall 34. A front wall 36 can extend between the first side wall 32 and the second side wall 34. The front wall 36 can be spaced apart from the rear end 14 of the car 10. The front wall 36 can be orientated at about 90°, or some other selected angle, relative to the upper portion 24. The well 26 can be used and sized to accommodate one or more golf bags (not shown).

With additional reference to FIG. 3B, which illustrates the cover 30 removed from the opening 28, the opening 28 can comprise an upper end 38, a lower end 40, a first side 42, and a second side 44. The upper end 38 can be at the upper portion 24 of the rear body 22. The lower end 40 can be at the front wall 36 of the well 26. The first and second sides 42 and 44 can extend from the upper end 38 to the lower end 40. Thus, the first and second sides 42 and 44 can extend along both the upper portion 24 and the front wall 36. The opening 28 can be positioned to provide access to components of the car 10 beneath the rear body 22, such as a rear end of the golf car powertrain.

The upper end 38 and portions of the first and second sides 42 and 44 proximate the upper end 38 can include an upper flange 46. The upper flange 46 can be recessed beneath the upper portion 24. The lower end 40 and portions of the first and second sides 42 and 44 proximate the lower end 40 can include a lower flange 48. The lower flange 48 can be recessed within the front wall 36 of the well 26.

The upper flange 46 can comprise one or more cut-out portions or notches 50 at the upper end 38 of the opening 28. The lower flange 48 can similarly comprise one or more cut-out portions or notches 52 at the lower end 40 of the opening 28. The lower flange 48 can further comprise a first extension 54 and a second extension 56. The first extension 54 can extend from the first side wall 42 and the second extension 56 can extend from the second side wall 44. The first extension 54 can be opposite the second extension 56. The first extension 54 can include a first aperture 58 and the second extension 56 can include a second aperture 60.

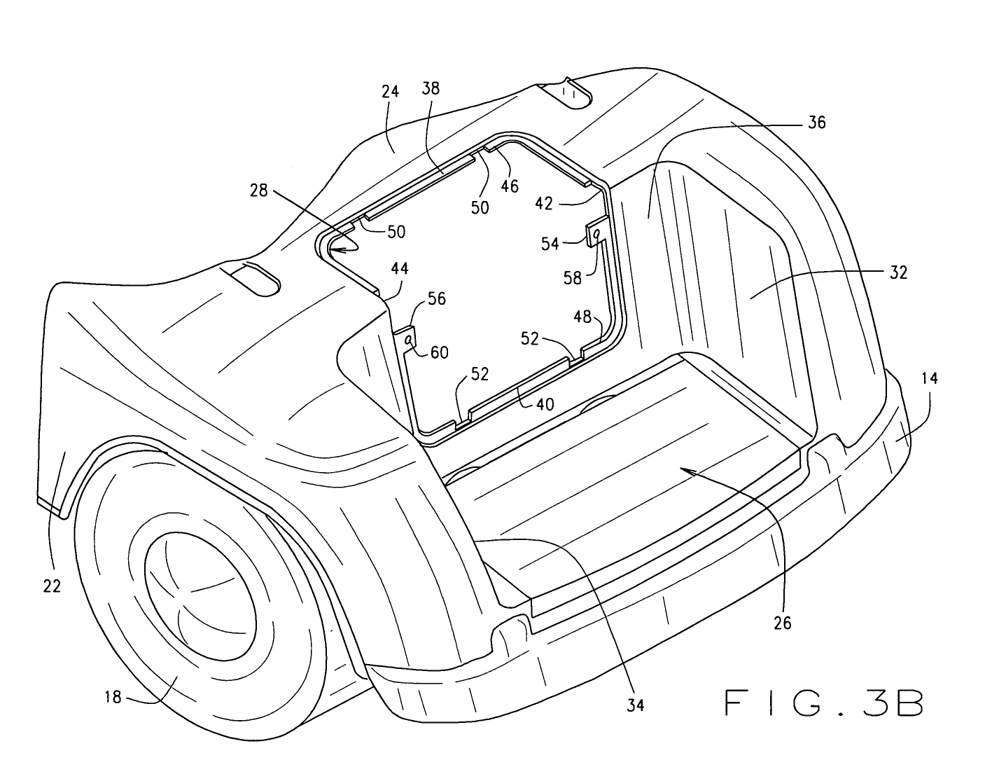

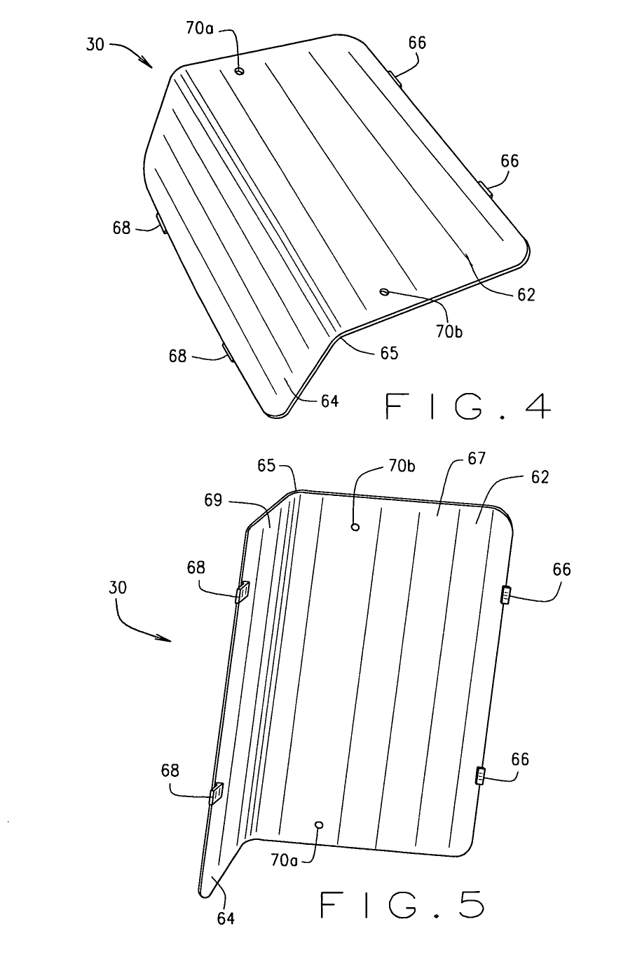

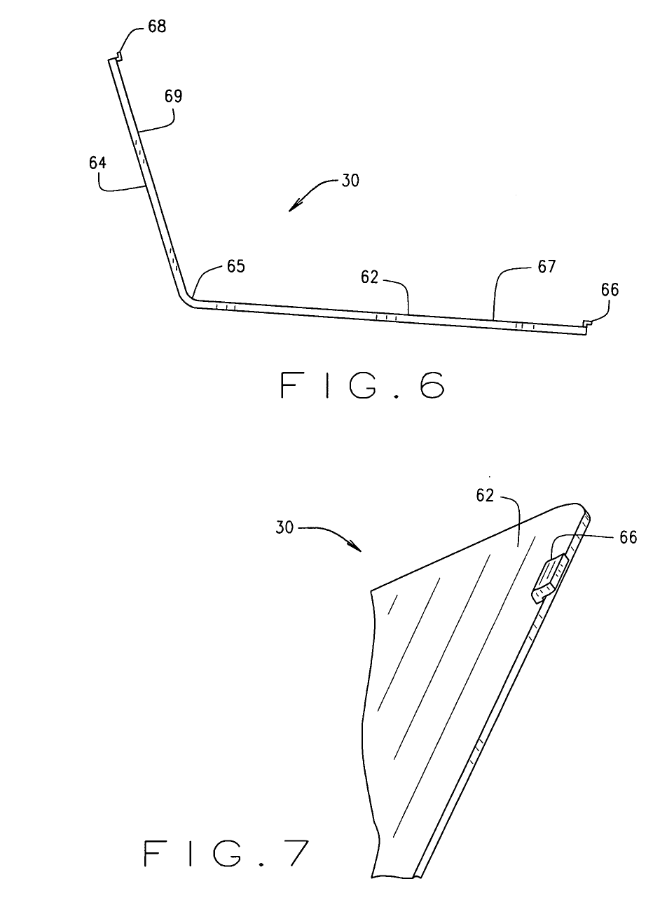

With additional reference to FIGS. 4-7, the cover 30 can comprise a first portion 62 and a second portion 64 that can be integral with the first portion 62. The first and second portions 62 and 64 can each be planar and can be orientated at an angle relative to each other. By way of non-limiting example, the first portion 62 can be orientated at an angle of greater than about 90° relative to the second portion 64. The angle of the first portion 62 relative to the second portion 64 can be greater than the angle that the upper end 38 of the opening 28 is disposed relative to the lower end 40. The first portion 62 and the second portion 64 can meet at a hinge portion 65. The first portion 62 and the second portion 64 can flex relative to each other at the hinge portion 65.

The first portion 62 can comprise at least one first retention detail 66. The retention detail 66 can take the form of a flange that can be mounted to an undersurface 67 of the first portion 62 and can extend from an end of the first portion 62. The second portion 64 can similarly include at least one second retention detail 68. The second retention detail 68 can be the same as or similar to the first retention detail 66. For example, the second retention detail 68 can be a flange mounted to an undersurface 69 of the second portion 64 and can extend from an end of the second portion 64.

The first portion 62 can further comprise one or more through holes 70. As illustrated, the first portion 62 can include a first through hole 70a and a second through hole 70b. The through holes 70a and 70b can be spaced apart at opposite ends of the first portion 62. The through holes 70a and 70b can be sized and configured to receive any suitable fastening device, such as a “J” clip.

The cover 30 can be made of any suitable material, such as a suitable polymer. The cover 30 can be made of a material that permits the first portion 62 to flex relative to the second portion 64 at the hinge portion 65.

Installation of the cover 30 within the opening 28 will now be described. The cover 30 can be positioned so that the retention details 68 of the second portion 64 are seated within the upper notches 50 and under the upper flange 46. The area of the second portion 64 proximate to the second retention details 68 can be seated on top of the upper flange 46 for support.

The cover 30 can then be flexed at the hinge portion 65 to position the retention details 66 of the first portion 62 within the lower notches 52 and under the lower flange 48. The area of the first portion 62 proximate to the first retention details 66 can be seated on top of the lower flange 48 for support.

When the cover 30 is seated within the opening 28, the first through hole 70a can be aligned with the first aperture 58 and the second through hole 70b can be aligned with the second aperture 60. Suitable fastening devices, such as “J” clips, can be inserted through the first hole 70a and the first aperture 58, as well as through the second through hole 70b and the second aperture 60. Mounting the cover 30 to the first extension 54 and the second extension 56 further secures the cover 30 within the opening 28.

The cover 30 can be removed from the opening 28 by removing the fasteners used to secure the cover 30 to the first extension 54 and the second extension 56. The first retention details 66 can then be removed from beneath the lower end 40 of the opening 28 and the second retention details 68 can be removed from beneath the upper end 38 of opening 28 to permit removal of the cover 30 from the opening 28. With the cover 30 removed from the opening 28, the opening 28 can be used to obtain access to components of the car 10 beneath the rear body 22, such as the rear end of the powertrain.

With renewed reference to FIGS. 1 and 2, a front seat assembly 72 can be mounted to the upper portion 24 of the rear body 22. The front seat assembly 72 can comprise a base portion 74 and a seat back 76. The base portion 74 can be mounted directly to the upper portion 24 of the rear body 22. The seat back 76 can be mounted to the upper portion 24 of the rear body 22 by one or more support mounts 78.

With reference to FIG. 2, a golf bag retention assembly 80 can be mounted to the supports 78. The retention assembly 80 can extend from the supports 78 and can be suspended above the well 26. The retention assembly 80 can comprise a harness or strap to secure one or more golf bags that are seated within the well 26 to the retention assembly 80.

The description herein is merely exemplary in nature and, thus, variations that do not depart from the gist of that which is described are intended to be within the scope of the disclosure. Such variations are not to be regarded as a departure from the spirit and scope of the disclosure.

What is claimed is:

1. An access panel for a golf car comprising:
a first planar portion;
a second planar portion integral with and orientated at an angle relative to said first planar portion;
a first retention detail extending from said first planar portion;
a second retention detail extending from said second planar portion; and
an aperture extending through said first planar portion.

2. The access panel of claim 1, wherein said first planar portion is orientated at an angle of greater than 90° relative to said second planar portion.

3. The access panel of claim 1, further comprising a hinge portion between said first planar portion and said second planar portion.

4. The access panel of claim 1, wherein said access panel comprises a polymer.

5. The access panel of claim 4, wherein said first planar portion is flexible relative to said second planar portion.

6. The access panel of claim 1, wherein said first retention detail extends from a first end of said access panel and said second retention detail extends from a second end of said access panel that is opposite said first end.

7. A golf car comprising:
a front end;
a rear end opposite said front end;
a rear body at said rear end comprising an upper portion and a golf bag retention well;
an opening that extends from said upper portion of said rear body to said retention well, said opening comprising:
a first flange at said upper portion of said rear body;
a second flange at said retention well of said rear body;
a first notch in said first flange; and
a second notch in said second flange.

8. The golf car of claim 7, further comprising a cover removably mounted to said opening.

9. The golf car of claim 8, further comprising a through hole extending through said cover.

10. The golf car of claim 8, wherein said cover comprises a polymeric material.

11. The golf car of claim 8, wherein said cover further comprises:
a first planar portion;
a second planar portion integral with said first planar portion and orientated at an angle relative to said first planar portion;
a first retention detail extending from said first planar portion, said first retention detail sized to pass through said first notch; and
a second retention detail extending from said second planar portion, said second retention detail sized to pass through said second notch.

12. The golf car of claim 7, wherein said opening further comprises a first extension extending from a first side wall of said opening and a second extension extending from a second side wall of said opening.

13. The golf car of claim 12, wherein said first extension further comprises a first aperture and said second extension further comprises a second aperture.

14. The golf car of claim 7, wherein said opening further comprises a first extension extending from said second flange and a second extension extending from said second flange opposite to said first extension.

15. A rear body of a golf car comprising:
an upper portion;
a golf bag retention well adjacent to said upper portion and recessed beneath said upper portion;
an opening in said rear body extending from said upper portion to said golf bag retention well;
a cover having a first planar portion and a second planar portion that is integral with said first planar portion at a hinge portion, said first planar portion is angled relative to said second planar portion, said cover is sized to cover said opening; and
a plurality of retention details mounted to said cover and operable to cooperate with said opening to retain said cover in said opening.

16. The rear body of claim 15, wherein said opening comprises:
a first flange at said upper portion of said rear body;
a second flange at said retention well of said rear body;
a first notch in said first flange; and
a second notch in said second flange.

17. The rear body of claim 16, wherein said first flange is seated within said first notch and abuts said upper portion of said rear body and said second flange is seated within said second notch and abuts said retention well of said rear body.

18. The rear body of claim 15, wherein said opening further comprises a first extension at a first side wall and a second extension at a second side wall.

19. The rear body of claim 15, wherein one of said first planar portion and said second planar portion further comprise at least one through hole.

20. The rear body of claim 15, wherein said rear cover comprises a polymeric material.

21. A golf car comprising:
a front end;
a rear end opposite to said front end;
a rear body at said rear end comprising an upper portion and a golf bag retention well;
an opening that extends from said upper portion of said rear body to said retention well, said opening comprising:
a first flange at said upper portion of said rear body;
a second flange at said retention well of said rear body;
a first notch in said first flange; and
a second notch in said second flange;
a cover covering said opening, said cover comprising:
a first planar portion;
a second planar portion that is integral with said first planar portion at a hinge portion, said first planar portion is angled more than 90° relative to said second planar portion;
a first retention detail extending from said first planar portion;
a second retention detail extending from said second planar portion;
wherein said cover is flexed at said hinge portion to bring said first planar portion into contact with said first flange and said second planar portion into contact with said second flange, said first planar portion is positioned such that said first planar portion is seated atop said first flange and said first retention detail is seated within said first notch and below said first flange, said second planar portion is positioned such that said second planar portion is seated atop said second flange and said second retention detail is seated within said second notch and below said second flange.
